(19) United States
(12) Patent Application Publication
(10) Pub. No.: US 2021/0268636 A1
(43) Pub. Date: Sep. 2, 2021

(54) Machine Tool

(71) Applicant: Robert Bosch GmbH, Stuttgart (DE)

(72) Inventors: Willy Braun, Neustetten (DE); Juergen Lennartz, Ostfildern (DE); Stephan Ulloa, Weilheim (DE); Carsten Diem, Ludwigsburg (DE)

(21) Appl. No.: 17/255,128

(22) PCT Filed: Jun. 3, 2019
(86) PCT No.: PCT/EP2019/064268

§ 371 Date: Dec. 22, 2020

(30) Foreign Application Priority Data
Jun. 28, 2018 (DE) 10 2018 210 553.7

(51) Int. Cl. B25F 5/00

(52) U.S. Cl. CPC B25F 5/006; B25D 17/043

(57) ABSTRACT

The disclosure relates to a machine tool, in particular a hand-held machine tool, comprising a housing and an electronics module, wherein the electronics module has a position-determining unit and a communications unit, wherein the electronics module can be supplied with energy via an at least partially independently formed energy unit. According to the disclosure, the electronics module is accommodated in an electronics housing, wherein the electronics housing is coupled to the housing of the machine tool.

### PRIOR ART

The publication DE 10 2016 201 454 A1 describes an anti-theft module for an electric power tool, comprising a position-determining unit for determining a geographical position of the anti-theft module, and at least one first data interface for transmitting position data to an external device. The anti-theft module is fixedly mounted on a cable that is connected to the electric power tool.

### DISCLOSURE OF THE INVENTION

The invention relates to a power tool, in particular a hand-held power tool, comprising a housing and an electronics module, wherein the electronics module has a position-determining unit and a communications unit, wherein the electronics module can be supplied with energy via an at least partially independent energy unit. It is proposed that the electronics module be accommodated in an electronics housing, wherein the electronics housing is coupled to the housing of the power tool. Advantageously, the electronics module can thereby be protected in an effective manner.

A power tool in this context is to be understood to mean, in particular, an appliance for performing work on workpieces by means of an electrically driven insert tool. The power tool may thus be realized as a hand-held power tool or as a floor-standing power tool. Typical power tools in this context are hand-held or floor-standing drills, screwdrivers, impact drills, hammer drills, jigsaws, circular saws, miter saws, planers, angle grinders, orbital sanders, polishing machines or the like. However, gardening appliances such as lawn mowers, lawn trimmers, pruning saws or the like may also be included under the term power tool. Furthermore, equipment that is typically used on construction sites is be understood as power tools. Examples of this are construction site radiators, heaters, blowers, pumps, mixing machines, measuring devices, construction site radios, battery charging devices, etc. The power tool may be realized as a corded mains-powered device or a cordless battery-powered device. The power tool has a housing in which at least one drive unit, in particular an electric motor, is accommodated. The drive unit is in particular connected to a tool receiver designed to receive a tool. The insert tool may be designed, for example, to be driven in rotation about, and/or in a linearly oscillating manner along, a work axis. The housing may be of a single-part or multi-part design. The housing is realized, in particular, as an outer housing, but it is also conceivable for the housing additionally to have an inner housing part that accommodates, for example, a transmission and/or percussion mechanism. The housing additionally has at least one handle, preferably at least two handles. The handle, or handles, is/are fixedly connected to the power tool. The power tool is realized, in particular, as an impact hammer, or demolition hammer. The power tool, realized as an impact hammer, or as a demolition hammer, has a percussion mechanism, in particular a linear percussion mechanism. The percussion mechanism is realized, in particular, as a pneumatic percussion mechanism. The power tool has a weight of at least 11 kg, preferably at least 16 kg, more preferably at least 25 kg. The power tool has, in particular, a percussion energy of at least 20 J, preferably at least 40 J, more preferably at least 60 J. The power tool, realized as an impact hammer, or as a demolition hammer, is designed, in particular, as a hand-guided power tool for ground working. The power tool has a housing axis that is perpendicular to the work axis. The maximum distance between two points of intersection of the housing axis with the housing corresponds to a housing width of the housing. Preferably, the work axis intersects the housing centrally. “Centrally” in this context is to be understood to mean, in particular, that the work axis is located not farther than 15% of the housing width, preferably not farther than 10% of the housing width, more preferably not farther than 5% of the housing width from the mid-point between the two points of intersection of the housing axis. In particular, the work axis is located substantially on the center of gravity of the power tool, and consequently, when the power tool is being guided, only a small expenditure of force is required in order to prevent the power tool from tilting. A “communications unit” is to be understood to mean, in particular, an interface for wireless unidirectional or bidirectional transmission of data between the electronics module and the power tool and/or an external device. Wireless transmission is typically effected using transmission standards such as WLAN, BT, BTLE, ZigBee, NFC, RFID, GSM, UMTS, LTE or the like. Clearly, a proprietary transmission is also conceivable here. The communications unit may also be used, inter alia, for programming, for installing updates, and for reading out or, if necessary, resetting the electronics module via an external device. The “position-determining unit” typically consists of a GPS receiver, but may also include other positioning services, such as Galileo or Glonass. In addition, the determination of position inside buildings may be based on WLAN, beacons or already existing infrastructure elements, such as smoke detectors equipped with BT or WLAN or the like. Clearly, a combination of outdoor and indoor positioning services is also possible. An “external device” describes a device that is not mechanically connected to the power tool. The external device communicates with the communications unit via the above-mentioned services, and for this purpose it itself has a corresponding data interface for wireless transmission of the data provided by the electronics module. The external device furthermore, in a known manner, comprises a processor and a working memory. An external device may be, for example, a smartphone, a smartwatch, smart glasses, a remote control specially designed for the power tool, but also a PC, a server or a data cloud. However, the external device may also be another electronics module, such that a plurality of electronics modules can communicate directly with each other. For the purpose of processing and forwarding the position data determined by the position-determining unit, the electronics module has a computing unit connected to the communications unit. This allows the data to be processed autonomously in a particularly advantageous manner without the need for a data connection to an external device. A “computing unit” is to be understood to mean any form of processor, e.g. microcontroller, DSP, ASIC or the like, for processing routines, programs and/or scripts independently of the code sequences and protocols used, including the necessary memory components. However, correspondingly discrete and hybrid designs may also be considered to be computing units. Since a plurality of electronics modules can thus communicate with each other, it is possible to set up a further network in order to establish communication with a server or a cloud via one or more of the other electronics modules in the case of no mobile network being available.

A partially independent energy unit is to be understood to mean, in particular, an energy unit via which the electronics module can be supplied with energy independently of an energy supply of the power tool. Advantageously, the partially independent energy unit may also be used to operate the electronics module without connecting a corded power tool to an electric power source, for example a mains electric power supply, or a battery power tool having a battery pack. An electronics housing that is coupled to the housing of the power tool, in this context, is to be understood to mean, in particular, that a movement of the housing of the power tool causes a movement of the electronics housing.

It is furthermore proposed that the electronics module have a movement sensor, in particular an acceleration and/or a rotation-rate sensor. The movement sensor is designed, in particular, to detect a change in position or operation of the power tool by means of the vibrations occurring during operation.

It is also proposed that the energy unit have an energy storage unit and a charging device. The energy storage unit is realized, in particular, as a battery cell. The battery cell may be realized, for example, as a round cell or as a coin cell. The battery cell is preferably realized as a Li-ion battery cell. The charging device is designed, in particular, to charge the energy storage unit. Preferably, the charging device can be connected to the energy supply of the hand-held power tool, for example to a mains electric power supply cable of the hand-held power tool or a battery pack.

It is additionally proposed that the electronics module have a temperature sensor. Advantageously, the temperature sensor can be used to monitor the temperature within the electronics module.

It is furthermore proposed that the electronics module have a monitoring unit for monitoring the power tool. In particular, the computing unit, the position-determining unit and the communications unit are assigned to the monitoring unit. The monitoring unit may be designed to transmit the determined position and/or the determined work location of the power tool to the external device. By this means, advantageously, the location of the power tool may be determined in the event of theft. Alternatively or additionally, it is conceivable that a work time, a work load or a work condition can be transmitted to the external device via the monitoring unit. The work time, the work load and/or the work condition in this case can be determined, in particular, by means of data of the movement sensor and/or of the temperature sensor. The work time may be determined, for example, on the basis of the position of the power tool. In the case of certain power tools such as, for example, a percussion hammer, very strong vibrations occur during operation of the power tool. These vibrations can be detected by means of the movement sensor, and as a result a work load for the user can be determined by the computing unit.

It is furthermore proposed that the power tool be designed such that it can be switched off and/or blocked via the electronics module. Advantageously, this can prevent unauthorized use of the power tool. It is conceivable, for example, that a switch-off or blocking signal is sent to the electronics module via the external device, and the electronics module is connected to the power tool in such a manner that the power tool can be controlled by the electronics module on the basis of the switch-off or blocking signal.

It is additionally proposed that the electronics housing be composed, at least partially, in particular entirely, of a plastic. It can thereby be ensured, advantageously, that the communications unit operates with the least possible interference. The electronics housing surrounds the electronics module in at least one spatial direction, preferably in at least two spatial directions, more preferably in three spatial directions. The spatial directions in this case are perpendicular to each other. The electronics housing is composed of plastic in at least one spatial direction, preferably in two spatial directions, more preferably in three spatial directions.

It is furthermore proposed that the electronics housing be accommodated in or on the housing of the power tool via a vibration damping unit. This can advantageously prevent damage to the electronics module resulting from vibrations and shocks occurring during operation of the power tool. In particular, the vibration damping unit comprises at least one damping element, which may be realized, for example, as an elastic element such as a rubber, or as a resilient element such as a helical spring. Preferably, the electronics housing is attached to a handle of the power tool that is connected to the housing of the power tool by means of the vibration damping unit. It is also conceivable for the housing to comprise an outer housing and an inner housing, with the vibration damping unit being arranged between the outer housing and the inner housing.

It is additionally proposed that the electronics housing have a flexible receiver for the energy storage unit. Advantageously, the energy storage unit can thereby be protected in a particularly effective manner against the vibrations and shocks that occur. The receiver spans a receiving space. A flexible receiver is to be understood to mean, in particular, a receiver having a receiving space that is flexible in respect of its position and/or flexible in respect of its size.

It is furthermore proposed that the energy storage unit be accommodated in a non-positive manner in the receiver. Advantageously, this allows the energy storage unit to be accommodated securely.

It is furthermore proposed that a force be applied to the receiver by means of a securing unit. Advantageously, this can further improve the accommodation of the energy storage unit and protect the energy storage unit from vibrations. The securing unit is in particular designed to be at least partially resilient.

It is furthermore proposed that the securing unit be arranged in such a manner that the securing unit acts crosswise, in particular substantially perpendicularly, in relation to a work axis of the power tool. In particular, the securing unit is thereby designed to be at least partially movable or deformable in a direction perpendicular to the work axis.

### DRAWINGS

Further advantages are given by the following description of the drawings. The drawings, the description and the claims contain numerous features in combination. Persons skilled in the art will expediently also consider them individually and combine them to form appropriate further combinations.

There are shown:

FIG. 1 a longitudinal section of a power tool according to the invention, in a first embodiment;

FIG. 2 a partial section through an electronics housing according to FIG. 1;

FIG. 3 a transverse section through the electronics housing according to FIG. 1;

FIG. 4 a longitudinal section of the power tool according to the invention, in a further embodiment.

### DESCRIPTION OF THE EXEMPLARY EMBODIMENTS

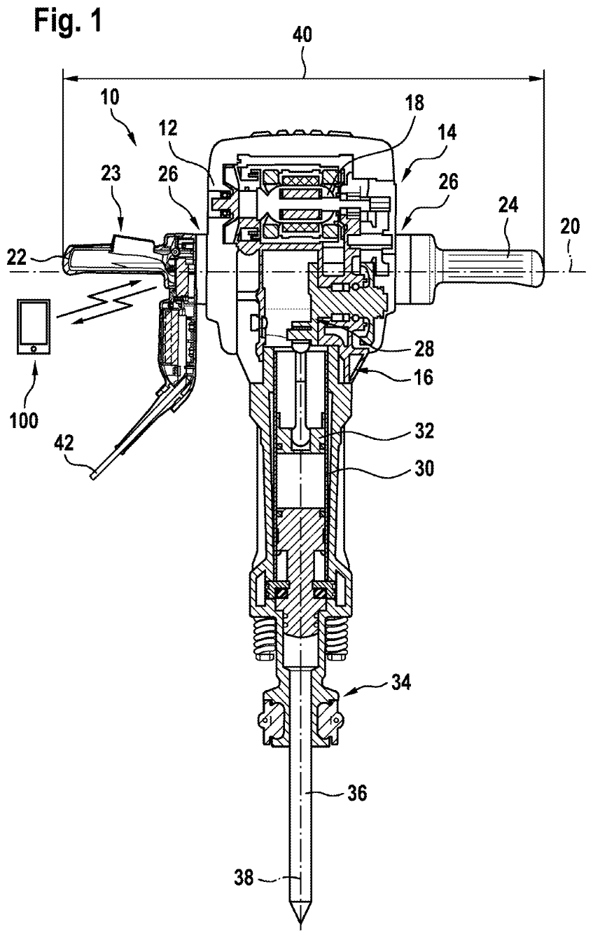

FIG. 1 shows a longitudinal section of a power tool 10 according to the invention, realized as an impact hammer. The power tool 10 has a housing 12, in which a drive unit 14 and a transmission unit 16 are arranged. The housing 12 of the power tool 10 is made of metal. Preferably, the housing 12 of the power tool 10 is made entirely of metal. The drive unit 14 has an electric motor 18, which is arranged in such a manner that a motor axis of the electric motor 18 is parallel to a housing axis 20. The housing 12 of the power tool 10 has a first handle 22 and a second handle 24. The handles 22, 24 are arranged on the sides of the housing 12 of the power tool 10. The handles 22, 24 are each connected to the housing 12 via a vibration damping unit 26. In particular, the handles 22, 24 are connected to the housing 12 in such a manner that allows a relative movement, between the handles 22, 24 and the housing 12, that is damped by the respective vibration damping unit 26. The transmission unit 16 has an eccentric gearing 28, via which the piston 32, arranged in a hammer tube 30, can be driven in a linearly oscillating manner. The power tool 10 has a tool receiver 34 in which an insert tool 36, for example realized as a chisel, can be received. A work axis 38 of the power tool 10 is coaxial with the hammer tube 30. The work axis 38 is substantially perpendicular to the housing axis 20. The housing axis 20 intersects the handles 22, 24 at their end points, such that the distance between the points of intersection of the housing axis 20 with the end points of the handles 22, 24 corresponds to a housing width 40 of the power tool 10. The handles 22, 24 are arranged on mutually opposite sides of the power tool 10. The handles 22, 24 are arranged on the same level. In particular, the handles 22, 24 are coaxial with each other. The power tool 10 is realized, for example, as a mains-operated appliance. The power tool 10 has mains electric power cable 42, via which the power tool 10 can be connected to an electric power source such as, for example, a mains electric power system, for the purpose of energy supply. The mains electric power cable 42 is connected to the power tool 10 via the handle 22. The handle 22 additionally comprises an operating switch 23, via which the power tool 10 can be switched on and off.

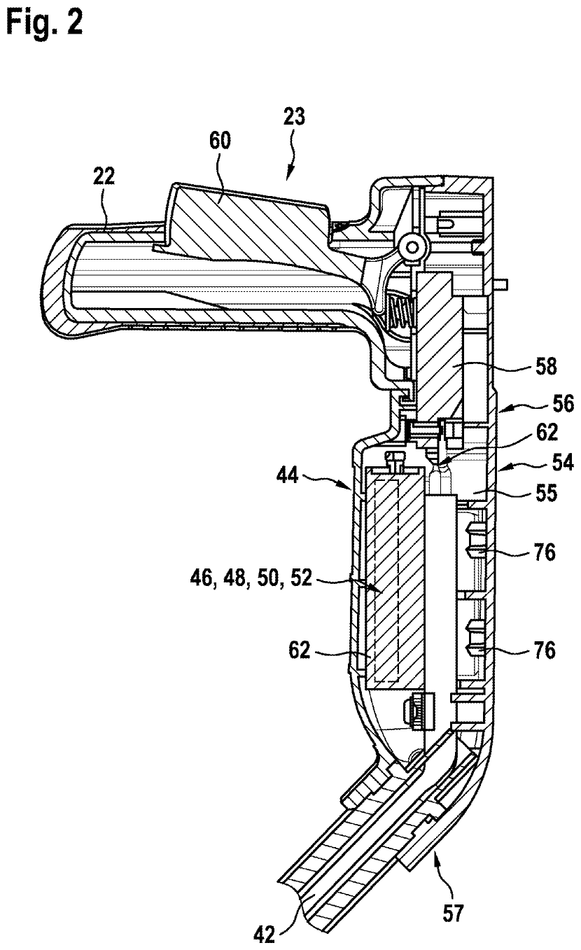

FIG. 2 shows an enlarged view of a partial section of the power tool 10 in the region of the handle 22. The power tool 10 has an electronics module 44. The electronics module 44 comprises a monitoring unit 46, to which there is assigned a computing unit 48, a position-determining unit 50 and a communications unit 52. The electronics module 44 furthermore comprises an energy unit 54, via which the electronics module 44 can be at least partially independently supplied with energy. The electrical components such as, for example, a microprocessor, an acceleration sensor and a rotation-rate sensor of the electronics module 44 are arranged on a printed circuit board (not represented). The position-determining unit 50 is realized, for example, as a GPS receiver, and the communications unit 52 is designed, for example, to transmit data by means of a mobile telephony network such as, for example, GSM, UMTS and/or LTE. The energy unit 54 has an energy storage unit 55 realized as a battery cell.

The electronics module 44 is accommodated in an electronics housing 56 that is arranged on the handle 22. The electronics housing 56 is of a two-part design, the individual parts of the electronics housing 56 and of the handle 22 being screw-connected to each other. Advantageously, the electronics housing 56 is connected to the handle 22 in such a manner that the electronics housing 56, and thus the electronics module 44, is protected against vibrations of the power tool 10 by means of the vibration damping unit 26. The electronics housing 56 is preferably composed entirely of a plastic, thereby ensuring that the communications unit 52 can be operated without interference.

The electronics housing 56 has a mains electric power cable inlet 57, via which the mains electric power cable can enter the electronics housing 56. The mains electric power cable 42 is fixed in the electronics housing 56 by means of a clamping element 43 realized, for example, as a clamping strip. The electronics housing 56 extends transversely, in particular substantially perpendicularly, in relation to the handle 22. The electronics module 44 is arranged between the mains electric power cable inlet 57 and the handle 22. The mains electric power cable 42 terminates within the electronics housing 56 and is electrically connected to an on/off switch 58. The on/off switch 58, and a switching lever 60 that is pivotably fastened to the handle 22, are assigned to the operating switch 23. The on/off switch 58, and thus the power tool 10, is designed to be controllable via the switching lever 60.

The voltage-carrying on/off switch 58 is connected to the electronics module 44 via a contact interface 62, enabling the electronics module 44 to be supplied with energy. The electronics module 44 in turn is electrically connected to the energy storage unit 55 via a connection element realized, for example, as a cable coupler. Preferably, if the power tool 10 is connected to an external electric power source, the electronics module 44 is supplied with energy via the mains electric power cable 42, and the energy storage unit 55 is charged. The energy storage unit 55 in this case is preferably charged irrespective of an operating state of the power tool 10. In particular, if the power tool 10 is not connected to an external electric power source, the electronics module 44 is supplied with energy via the energy storage unit 55.

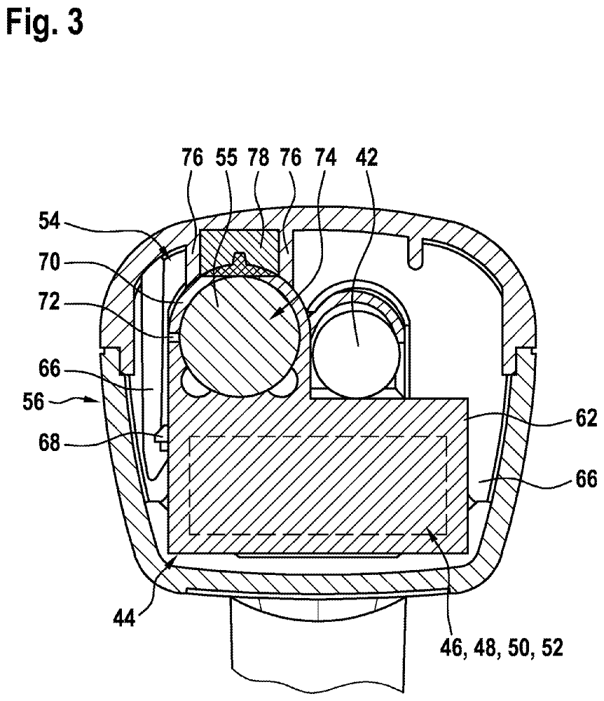

FIG. 3 shows a cross section through the electronics housing 56 in the region of the electronics module 44. The electronics module 44 has an electronics module housing 62 that is separate from the electronics module 44. The electronics module housing 62 is of a cup-type design and, when the electronics module 44 is being assembled, the printed circuit board of the electronics module 44, together with the electronic components, is pushed into the electronics module housing 62 and then encapsulated with a resin-like hardening potting compound in order to fix the printed circuit board in a vibration-resistant manner. The electronics module 44, in particular the electronics module housing 62, is connected in a non-positive and positive manner to the electronics housing 56. The connection is effected, in particular, via resilient latching arms 55, which are integral with at least one of the parts of the electronics housing 56. The latching arms 66 are connected in a non-positive and positive manner to corresponding connection elements 68 on the electronics module housing 62.

Arranged in the electronics housing 56 there is a receiver 70 that is designed to receive the energy storage unit 55, which is realized as a battery cell. The energy storage unit 55 is assigned to the electronics module 44 and, in particular, is integral with the electronics module housing 62. Alternatively, it is also conceivable for the receiver 70 to be formed by the electronics housing 56. The receiver 70 is in the shape of a cylinder, and has a continuous slot 72 along its longitudinal extent. The receiver 70 spans a receiving region 74. Owing to the slot 72, the receiver 70 is of a flexible design, such that the receiving region 74 can be varied. In particular the receiver 70 is realized in such a manner that the receiving region 74 can be reduced in size as a result of an externally applied force, and the receiving region 74 can be enlarged as a result of an internally applied force. The electronics housing 56 comprises at least one support element 76, against which the energy storage unit 55 bears, or on which it is supported. In particular, the part of the electronics housing 56 that comprises the latching arms 66 has two pairs of support elements 76 realized as housing ribs. Arranged between the support elements 76 in each case there is a securing element 78, which is composed of an elastic material, for example a rubber. The receiver 70 and the securing elements 78 are shaped and/or arranged in such a manner that, when the electronics module 44 is being mounted in the electronics housing 56, a force is applied externally to the receiver 70 by the securing elements 78, so that the energy storage unit 55 arranged in the receiver 70 is mounted substantially without play and in a vibration-damped manner. The slot 72, the support elements 76 and the securing elements 78 are thus assigned to a securing unit 80 that additionally secures the energy storage unit 55.

The monitoring unit 46 is designed, in particular, to detect a connection, or an interruption of the connection, of the power tool 10 to an electric power source, in particular the connection, or an interruption of the connection, of the mains electric power cable 42 to a mains electric power supply system. The interruption of the connection in this case may be effected, for example, by disconnection of the mains electric power cable 42 from the electric power source, by damage to or severing of the mains electric power cable 42, or by actuation of a switch.

The monitoring unit 46 is designed, in particular, to transmit status information, based on the status variables acquired by the electronic components of the electronics module 44, to an external device 100 (see FIG. 1). The external device 100 is realized, for example, as a smartphone. The monitoring unit 46 transmits the status information to the external device 100 at flexible or fixed time intervals. It is conceivable for the time intervals of the transmitted status information that is transmitted to the external device 100 to differ in dependence on the status of connection of the power tool 10 to an electric power source. The status information includes, in particular, at least one geographical position of the power tool 10, or of the electronics module 44, detected by means of the position-determining unit 50. Advantageously, in the event of theft of the power tool 10, its location can thereby be determined with precision. Besides the geographical position, it is additionally conceivable for information relating to a work time, a work load and/or a work condition to be concomitantly transmitted in dependence on the status of connection of the power tool 10 to the electric power source. This advantageously allows optimal tracking of the operation of the power tool 10.

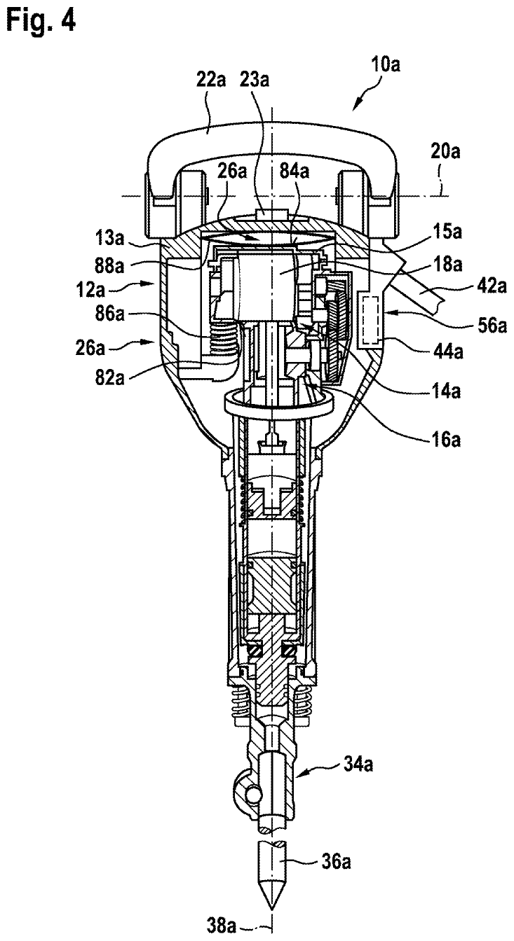

FIG. 4 shows a second embodiment of the power tool 10a according to the invention. The power tool 10a is likewise realized as an impact hammer. Identical features, or features that have substantially the same function, are denoted by the same references and by an additional letter.

The percussive power tool 10a has a housing 12a. The housing 12a comprises an outer housing 13a and an inner housing 15a, which are connected to each other via a vibration damping unit 26a. The drive unit 14a and the transmission unit 16a, together with the percussion mechanism, are arranged in the inner housing 15a. The inner housing 15a is preferably made of metal, in particular of aluminum. The outer housing 13a is preferably made of a plastic. The electric motor 18 has a motor axis that is parallel to a housing axis 20a of the power tool 10a and a work axis 38a. The inner housing 15a has an underside 82a that faces toward an insert tool 36a received in a tool receiver 34a, an upper side 84a that faces away from the insert tool 36a. The vibration damping unit 26a has a first vibration element 86a and a second vibration element 88a. The vibration elements 86a, 88a are arranged between the inner housing 15a and the outer housing 13a in such a manner that vibrations emanating from the inner housing 15a are transmitted, having been damped, to the outer housing 13a. The first vibration element 86a is arranged between the underside 82a of the inner housing 15a and the outer housing 13a. The first vibration element 86a is realized, for example, as a helical spring. The second vibration element 88a is arranged between the upper side 84a and the outer housing 13a. The second vibration element 88a is composed, for example, of a spring steel strip. The first and the second vibration element 86a, 88a are preferably arranged in such a manner that the effective direction of the vibration elements 86a, 88a corresponds substantially to the work axis 38a of the power tool 10a, and consequently the recoil generated by the percussive impulse is damped in an effective manner. Arranged within the housing 12a of the power tool 10a there is an electronics housing 56a. Arranged in the electronics housing 56a there is an electronics module 44a that corresponds substantially to the electronics module 44 according to FIG. 2. The electronics housing is advantageously integral with the outer housing 13a of the power tool 10a. As a result, advantageously, the electronics module 44a is accommodated so as to be substantially isolated in respect of vibration.

Alternatively, however, it is also conceivable for the electronics housing 56a to be connected to the outer housing 13a in a non-positive, positive and/or materially bonded manner. Rotatably arranged on the outer housing 13a of the power tool 10a there is a handle 22a, which is realized as a stirrup grip. The power tool 10a is realized as a mains-powered appliance, and has a mains electric power supply cable 42a. The operating switch 23a is arranged, at least partially, on the outer housing 13a. In particular, the switching lever 60a is arranged centrally on the upper side of the outer housing 13a.

It is likewise conceivable for the hand-held power tool 10, 10a to be realized, in an alternative embodiment, as a battery-operated hand-held power tool.

1. A power tool, in particular a hand-held power tool, comprising:
a housing; and
an electronics module accommodated in an electronics housing coupled to the housing of the power tool, the electronics module including a position-determining unit and a communications unit, and configured to be supplied with energy via an at least partially independent energy unit.

2. The power tool as claimed in claim 1, the electronics module further comprising
at least one of an acceleration sensor and a rotation-rate sensor.

3. The power tool as claimed in claim 1, the electronics module further comprising:
a monitoring unit configured to monitor the power tool.

4. The power tool as claimed in claim 1, wherein the power tool is configured to be at least one of switched off and blocked via the electronics module.

5. The power tool as claimed in claim 1, wherein the electronics housing is composed, at least partially, of a plastic.

6. The power tool as claimed in claim 1, wherein the electronics housing is coupled to the housing of the power tool via a vibration damping unit.

7. The power tool as claimed in claim 1, wherein the electronics housing includes a flexible receiver configured to receive the energy storage unit of the energy unit.

8. The power tool as claimed in claim 7, wherein the energy storage unit is accommodated in a non-positive manner in the flexible receiver.

9. The power tool as claimed in claim 7, wherein a force is applied to the receiver by means of a securing unit.

10. The power tool as claimed in claim 9, wherein the securing unit is configured such that the securing unit acts crosswise in relation to a work axis of the power tool.

11. The power tool as claimed in claim 10, wherein the securing unit is configured such that the securing unit acts substantially perpendicularly in relation to the work axis of the power tool.
